(19) United States
(12) Patent Application Publication
(10) Pub. No.: US 2015/0323370 A1
(43) Pub. Date: Nov. 12, 2015

(54) Method for Evaluation for Measurement Signals of a Level Gauge

(71) Applicant: ENDRESS+HAUSER GMBH+CO. KG, Maulburg (DE)

(72) Inventors: Stefan Gorenflo, Hausen (DE); Alexey Malinovskiy, Maulburg (DE); Piotr Paczoski, Wroclaw (PL); Herbert Schroth, Schopfheim (DE); Dietmar Spanke, Steinen (DE); Mariusz Szwagrzyk, Wroclaw (PL)

(21) Appl. No.: 14/652,299

(22) PCT Filed: Dec. 6, 2013
(86) PCT No.: PCT/EP2013/075744

§ 371 Date: Jun. 15, 2015

(30) Foreign Application Priority Data
Dec. 20, 2012 (DE) 10 2012 112 749.2

(51) Int. Cl. G01F 23/00; G01F 23/284; G01F 23/296

(52) U.S. Cl. CPC G01F 23/0061; G01F 23/2962; G01F 23/284

(57) ABSTRACT

A method for evaluation of measurement signals of a level gauge, which works according to the transit time principle, comprising the steps of transmitting a transmission signal towards a filling material; receiving an echo signal of the transmission signal; determining a fill level of the filling material according to the transit time principle of the echo signal; determining at least one parameter of the echo signal; and storing the values of the at least one parameter and the corresponding fill level. The at least one parameter is a phase position of the echo signal and/or a rate at which a height of the filling material in a tank changes and/or a change in amplitude of the echo signal and/or a temperature of the filling material and/or a temperature change of the filling material and/or a change in the amplitude variation of the echo signal.

The invention relates to a method for evaluation of measurement signals from a level gauge, working according to the transit time principle, and a corresponding level gauge.

One measurement method that is known from a plurality of measurement methods for determining the fill level of a tank is the transit time measurement method. In this measurement method, for example, microwaves are emitted by an antenna device and the echo signals reflected at the fill level are detected, wherein the transit time of the measurement signal is a measure of the distance. Thus, the fill level of the medium in a tank can be determined from half the transit time value. In this case, the echo curve represents the entire signal curve as a function of time, wherein each measured value of the echo curve corresponds to the amplitude of an echo signal that is reflected by the surface at a certain distance. The transit time measurement method is essentially divided into two methods of determination: In the time difference measurement, the time required by a broadband wave signal pulse for the distance traveled is determined. In the sweep frequency difference measurement (FMCW—Frequency Modulated Continuous Wave), the transmitted frequency-modulated, high-frequency signal is determined for the reflected, received, frequency-modulated high-frequency signal. There is also no limitation to a specific method of determination. Level gauges that use transit time methods are offered and sold by the applicant under the name Microplot or Levelflex.

EP 2 418 465 A1 describes a fill level measurement, and in particular, an electronic unit for determining a functional relationship between the fill level and the amplitude of an echo signal that is reflected by the fill level and received by the level gauge. In this way, the accuracy of the level determined can be increased.

A correlation between the amplitude of the echo signal received and the fill level is not accurate enough in many cases in order to determine the fill level with the desired accuracy. In particular, the determination of the fill level becomes less accurate the more time elapses between measurements because scales or sediments collect on the antenna device.

The object of the invention is to provide a method and a level gauge that make it possible to determine the fill level of the filling material with a high accuracy.

The object of the invention is achieved by the method according to the invention for the evaluation of measurement signals of a level gauge operating according to the transit time principle. The method comprises the steps of transmitting a transmission signal towards a filling material, receiving an echo signal of the transmission signal, determining a fill level of the filling material according to the transit time principle of the echo signal, determining at least one parameter of the echo signal, storing the values of at least one parameter and the corresponding fill level in a first table, characterized in that the at least one parameter is a phase position of the echo signal and/or a rate at which the level of the filling material in the tank changes and/or a change in amplitude of the echo signal and/or a temperature of the filling material and/or a temperature change of the filling material and/or a change in the amplitude variation of the echo signal.

The type of installation can be inferred from the amplitude variation of the echo signal as a function of the fill level. In particular, it can be inferred whether the tank is a measuring tube, in particular, a bypass, a surge pipe, or a free field.

A varying diameter of the tank can be inferred from the phase position and/or the course of the phase position or the change in the phase position of the echo signal as a function of the fill level. A changing diameter can occur, for example, due to a blockage or certain deflectors, such as stirrer blades or cornices. Furthermore, the phase position can be used for very accurate determination of the fill level.

A diagnosis for the detection of scales or sediments on a transmitter/receiver, or a probe for guiding the radar waves can be done by considering the rate at which a height of the filling material in the tank changes as a function of the filling material. Furthermore, clogged inlets and outlets can be detected.

It is possible to identify certain process characteristics and apply appropriate algorithms adaptively from the change in the amplitude variation of the echo signal as a function of the fill level. A change in the amplitude variation is an indication of at least one modified process parameter.

In this way, process errors can be detected, such as clogging of the surge pipe, a “flooding” of a coupling, measurement errors caused by volatilization of the filling material in a gas phase, temporally variable deflectors, such as stirrer blades or cornices in the tank.

According to another embodiment, a second table is created following a predetermined period of time and creation of the first table, and that at a certain fill level, these filling-level-related values of the one parameter from the first table and from the second table are compared to determine the extent of deviation.

The predetermined period may be several days, preferably several weeks, more preferably several months, even more preferably several years.

By comparing a first table and a second table changes in the values of the first table can be observed. The differences in the values of the tables are directly proportional to the period of time between recording of the first and the second tables. A signal or an alarm is triggered if the difference exceeds a predetermined tolerance value.

A deviation can no longer be tolerated if at a certain fill level the corresponding values of the one parameter from the first and the second tables at this fill level differ by more than 15%, preferably by more than 10%, more preferably by more than 5%. If a very large deviation is detected, an alarm is triggered, for example.

In this way, process errors too can be detected more accurately, such as the clogging of the surge pipe, “flooding” of the coupling, measurement errors caused by the formation of a gas phase from the filling material, temporally variable deflectors, such as stirrer blades or cornices.

According to another embodiment, the level gauge, in particular a transmitter/receiver of the level gauge, is cleaned upon the occurrence of a predetermined deviation of one of the values of the at least one parameter at the same fill level between the first table and the second table.

According to another embodiment, the cleaning comprises purging, particularly air purging.

The object of the invention is also achieved by a level gauge, in particular a level gauge for the method according to the invention. It comprises a transmitter/receiver, which can send transmission signals towards a filling material and receive echo signals, a signal processing unit for determining the fill level of the filling material from at least one parameter of the echo signal according to the transit time principle, a memory unit for storing the values of the at least one parameter of the echo signal and the corresponding fill level in a table, wherein the at least one parameter is a phase position and/or a rate at which a height of the filling material in the tank changes and/or a change in amplitude and/or a temperature of the filling material and/or a temperature change of the filling material and/or a change in the amplitude variation.

With reference to preferred exemplary embodiments, the invention is illustrated in further detail in the following, using the figures. Illustrated are:

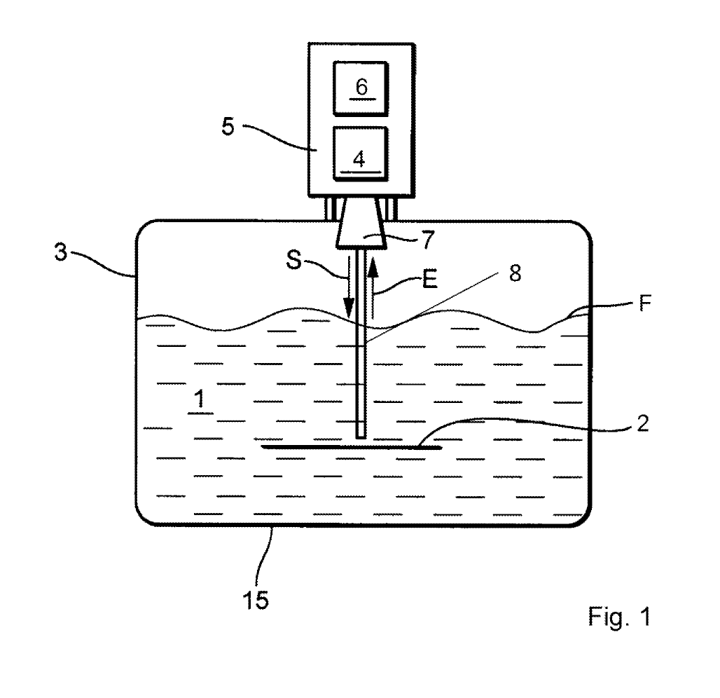

FIG. 1 shows an arrangement for fill level measurement with a level gauge operating according to the transit time principle,

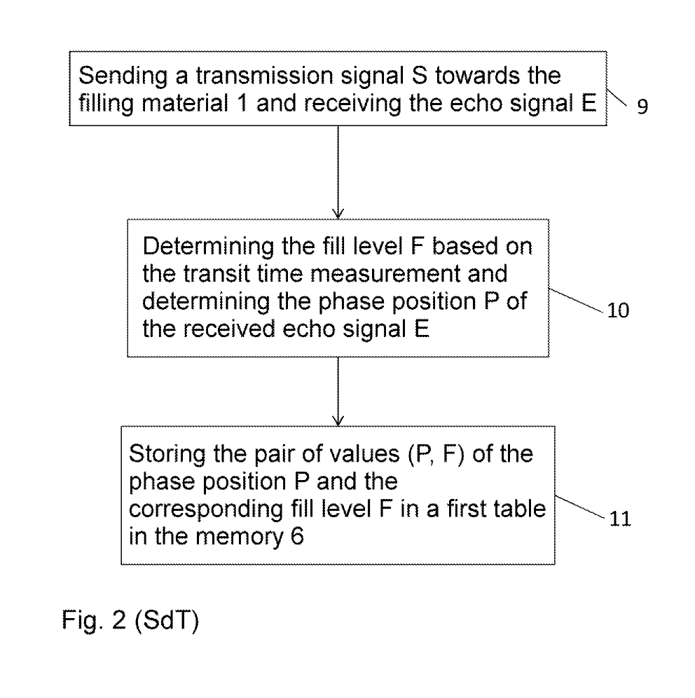

FIG. 2 is a flowchart to create a table from the determined phase positions and the corresponding fill levels according to the prior art,

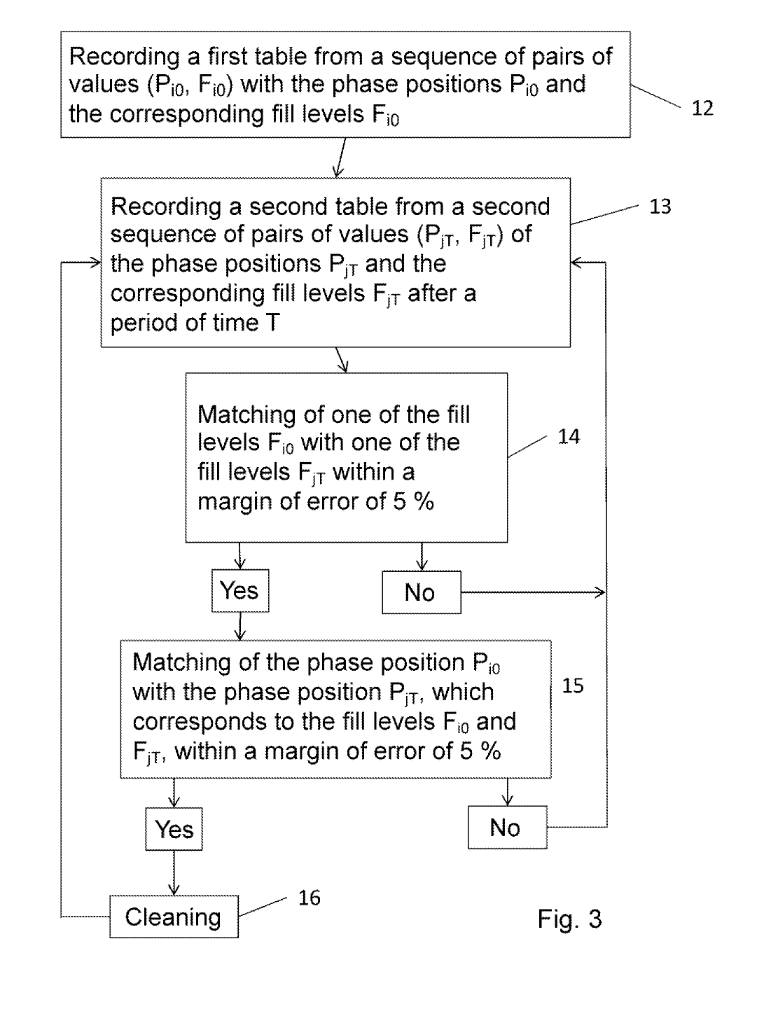

FIG. 3 is a flowchart for comparing a first to a second table, which was recorded after a specified period of time.

FIG. 1 shows an arrangement for measuring the fill level according to the prior art. A tank 3 filled with a filling material 1 is shown. In the upper part of the tank 3, a level gauge 5 that works according to the transit time principle is arranged. For example, a level gauge working with microwaves or ultrasonic waves could be a suitable level gauge 5. The level gauge 5 is used to measure a fill level F of the filling material 1 in the tank 3. A deflector 2 is shown as an example in the tank 3. Deflectors 2 are, e.g., fixtures within the tank 3, agitators and, of course, any other structure that may cause reflections.

The level gauge 5 has at least one transmitter/receiver 7 for sending transmission signals S and for receiving echo signals E. In the illustrated exemplary embodiment, a single transmitter/receiver 7, which transmits and receives, is provided. However, one transmitter/receiver for transmitting and at least one more transmitter/receiver for receiving may be provided. Alternatively, instead of the transmitter/receiver 7, a probe 8 may be present in the form of a waveguide on which the transmission signals S and echo signals E can be guided.

The transmission signals S are transmitted towards the filling material 1 and reflected by the surface of the filling material 1, as well as the tank 3 and the deflectors 2 in the tank 3. The superposition of these reflections forms the echo signal E. In the fill level measurement according to the transit time principle, transmission signals S, e.g. microwave or ultrasonic pulses, are periodically emitted towards a filling material 1. The echo signals E of the transmitted pulses S are received and fed to a signal processing unit 4, which uses the received echo signals E to derive an echo function, which contains the amplitudes A of the echo signals E as a function of their transit time t.

FIG. 2 shows how a table is created from the determined phase positions and the corresponding fill levels according to the prior art. First, the transmission signal S is sent towards the filling material 1 by means of the transmitter/receiver 7. The transmission signal S is reflected by the fill level F, returns as an echo signal S and is received by the transmitter/receiver 7 (see block 9). The signal processing unit 4 determines the phase position P and the corresponding fill level F as a pair of values (P, F) (see block 10) and stores this pair of values (P, F) in the memory 6 (see block 11).

FIG. 3 shows the method according to the invention. Within a first time interval, a first sequence of pairs of values (Pᵢ₀, Fᵢ₀) with i=1, 2, 3 . . . is recorded and stored in a first table (see block 12). After a predetermined period of time T has elapsed, a second sequence of pairs of values (P_{jT}, F_{jT}) with j=1, 2, 3 . . . is recorded within a second time interval (see block 13), wherein the first and the second time intervals are short compared to the period of time T.

If one of the fill levels Fᵢ₀, for example F₃₀, from the first sequence of pairs of values (Pᵢ₀, Fᵢ₀) matches one of the fill levels F_{jT}, for example F_{2T}, from the second sequence of pairs of values (P_{jT}, F_{jT}) within a margin of error of 5% (see block 14), the phase positions P₃₀ and P_{2T} from the first and second sequences of pairs of values (Pᵢ₀, Fᵢ₀) and (P_{jT}, F_{jT}) respectively that correspond to the fill levels F₃₀ and F_{2T} respectively are compared. If the phase positions P₃₀ and P_{2T} match within a margin of error of 5% (see block 15), other pairs of values (P_{iT}, F_{jT}) can be recorded; otherwise, cleaning is started (see block 16).

The method according to the invention which is shown in FIG. 3 using a flowchart is not limited to the phase position of the echo signal. Other parameters, such as the rate at which the level of the filling material 1 changes in the tank 3 and/or a variation in amplitude of the echo signal E and/or temperature of the filling material 1 and/or a change in temperature of the filling material 1 and/or a change in the amplitude variation of the echo signal E, can be determined as a function of the fill level instead of the phase position and used for analysis.

### LIST OF REFERENCE NUMBERS

1. Filling material
2. Deflector
3. Tank
4. Signal processing unit
5. Level gauge
6. Memory
7. Transmitter/receiver (transceiver)
8. Probe
S. Transmission signal
F. Fill level
E. Echo signal
P. Phase position

1-5. (canceled)

6. A method for evaluation of measurement signals of a level gauge, which works according to the transit time principle, comprising the steps of:
transmitting a transmission signal towards a filling material;
receiving an echo signal of said transmission signal;
determining a fill level of the filling material according to the transit time principle of said echo signal;
determining at least one parameter of said echo signal; and
storing the values of the at least one parameter and the corresponding fill level in a first table, wherein:
the at least one parameter is a phase position of said echo signal and/or a rate at which the level of the filling material in a tank changes and/or a variation in the amplitude of said echo signal and/or a temperature of the filling material and/or a temperature change of the filling material and/or a change in the amplitude variation of said echo signal.

7. The method according to claim 6, further comprising:
a second table is created after a predetermined period of time has elapsed since said first table was created and in that at a certain fill level, the values corresponding to this filling level of the one parameter from said first table and from said second table are compared to determine the extent of deviation.

8. The method according to claim 7, wherein:
said level gauge is cleaned upon the occurrence of a predetermined deviation of one of the values of the at least one parameter at the same fill level between said first table and said second table.

9. The method according to claim 8, wherein:
the cleaning is an air purging.

10. A level gauge, in particular a level gauge for a method which comprises the steps of transmitting a transmission signal towards a filling material;
receiving an echo signal of said transmission signal; determining a fill level of the filling material according to the transit time principle of said echo signal; determining at least one parameter of said echo signal; and storing the values of the at least one parameter and the corresponding fill level in a first table, wherein: the at least one parameter is a phase position of said echo signal and/or a rate at which the level of the filling material in a tank changes and/or a variation in the amplitude of said echo signal and/or a temperature of the filling material and/or a temperature change of the filling material and/or a change in the amplitude variation of said echo signal,
to the level gauge, comprising:
a transmitter/receiver, which can send transmission signals towards a filling material and receive echo signals;
a signal processing unit for determining the fill level of the filling material from at least one parameter of the echo signal according to the transit time principle; and
a memory for storing the values of the at least one parameter of the echo signal and the corresponding fill level in a table, wherein:
the at least one parameter is a phase position of the echo signal and/or a rate at which a height of the filling material in a tank changes and/or a change in amplitude of the echo signal and/or a temperature of the filling material and/or a temperature change of the filling material and/or a change in the amplitude variation of the echo signal.

11. The method according to claim 9, wherein:
the purging is an air purging.

12. The method according to claim 8, wherein:
a transmitter/receiver of said level gauge is cleaned.
